(19) United States
(12) Patent Application Publication
(10) Pub. No.: US 2023/0165263 A1
(43) Pub. Date: Jun. 1, 2023

(54) NEW PROCESS OF TREATMENT OF FRUIT AND VEGETABLES

(71) Applicant: XEDA INTERNATIONAL, Saint Andiol (FR)

(72) Inventor: Alberto SARDO, CHATEAURENARD (FR)

(21) Appl. No.: 17/925,165

(22) PCT Filed: May 18, 2021
(86) PCT No.: PCT/EP2021/063114

§ 371 Date: Nov. 14, 2022

(30) Foreign Application Priority Data
May 19, 2020 (FR) FR2005027

(51) Int. Cl. A23B 7/154; A23B 7/16; A23L 3/3517

(52) U.S. Cl. CPC A23B 7/154; A23B 7/16; A23L 3/3517

(57) ABSTRACT

The present invention relates to a treatment process for treating fruits and vegetables with one or more mono- and diglycerides of dietary fatty acids, that provides the means to obtain a homogeneous coating and thereby slow down the aging of the fruits and vegetables so treated.

The present invention relates to a new treatment process for treatment of fruits and vegetables.

Indeed, it is important for fruits and vegetables to conserve and not lose their organoleptic qualities, while retaining an appealing appearance when they are placed on the market in order to promote rapid consumption thereof. However, after being harvested, and until they are placed on the market, fruits and vegetables are commonly stored for relatively long periods during which they become dehydrated, and often fall victim to a surface oxidation phenomenon, known as scald.

Various different products are used for coating fruits and vegetables, in order to enhance the appearance and conservation thereof. Mention may thus be made of the product Semperfresh® which is a sucrose ester based product.

The application of the coating compositions generally requires prior dissolution in water of the product, which is then applied by immersion, spraying or showering on the fruits.

E471 is a food additive composed of mono- and diglycerides of dietary fatty acids. It is considered innocuous which explains its widespread use in the food industry (for example in the industrial production of bread and bakery/confectionery products). It serves as an emulsifier, gelling agent, antioxidant, carrier for colouring agents, and a coating agent. In the latter application, the process generally involves dissolving it in water, after which it is applied by immersing the fruits in the solution, or spraying or showering the solution on the fruits.

However, these application methods are unsatisfactory because they require water to be applied to the fruits. In addition, the mono- and diglycerides of fatty acids have a high viscosity, which renders the application thereof difficult. In particular, the vaporisation of mono- and diglycerides of fatty acids under usual working conditions effectively results in an inhomogeneous coating, forming agglomerates on the products which are not compatible with marketing related requirements and do not contribute to the satisfactory conservation thereof.

In addition, certain fruits such as strawberries and pears for example are extremely fragile such that any handling or treatment thereof is not without damage, which renders certain treatments impossible (immersion, waxing, individual packaging, etc.).

It is therefore necessary to provide a treatment process to appropriately address these difficulties.

In an unexpected manner, the present inventors have developed an application process for applying the mono- and diglycerides of fatty acids which makes it possible to enhance the quality of the coating. In addition, they have also brought to light the antioxidant activity of mono- and diglycerides of fatty acids on the coated fruits, making it possible to effectively avoid the phenomenon of scald.

Thus, according to a first object, the present invention relates to a treatment process for treating fruits and vegetables by means of a coating composition, the said process including:
the thermal fogging of the said composition at a temperature comprised between 250° C. and 330° C.;
the application of the aerosol of the said composition thus obtained on the said fruits and vegetables; and such that the said composition comprises:
one or more mono- and diglycerides of dietary fatty acids, and
a solvent having a boiling point temperature of between 150 and 260° C.

It has thus been demonstrated that despite the difficulties in applying the mono- and diglycerides of fatty acids, this process provides for a homogeneous coating which serves as the means for inhibiting gas exchanges between the fruit and the atmosphere, thereby slowing down the metabolism of the fruit.

The process according to the invention thus results in the coated fruit becoming impermeable (moisture-proof) which leads to a reduction in water loss and a marked improvement in quality due to the effect of the delaying of the ripening process.

Under the target temperature conditions, the process according to the invention makes it possible to obtain an aerosol of good quality, by forming a very fine mist corresponding to a particle size that is less than or equal to approximately 10 microns.

The process according to the invention therefore provides the means to obtain a homogeneous coating covering stored fruits and vegetables, with a protective effect that slows down the ripening and surface browning (scald) when the fruits leave the cold room and are exposed to ambient conditions.

According to the invention, the solvent in this instance provides the action of vector for the mono- and diglycerides of fatty acids at the target nebulisation temperature.

Thermal fogging (or thermonebulisation) is understood to refer to a process that consists in applying an extremely fine mist (wherein the size of the droplets is of the order of a micrometre), which is produced by injection of a liquid into a stream of hot air, which serves as a carrier for the said treating composition. The mist thus produced makes possible a homogeneous application.

This technique is known per se and is described in the French patent applications FR 98 015305 and FR 99 04534.

The thermal fogging could advantageously be implemented by using a thermal fogger, as described in the patent document FR 87 04 960, and more particularly by means of the ELECTROFOG® device marketed by the company XEDA INTERNATIONAL.

The thermal fogger typically consists of a high pressure fan, an electrical resistance, and a positive displacement pump that ensures strict maintenance of regularity of the characteristics of the mist produced and a very gradual, progressive introduction of the treating composition within the storage room.

In a conventional manner, the conditions that make it possible to obtain a drop size of 0.5 to 10 microns, in particular of the order of a micron, that is characteristic of a thermal fogging mist, comprise heating of the air to a temperature of 400° to 650° C. prior to the injection of the liquid.

The document FR9415329 describes in particular the thermal fogging at the temperature of the mist at the outlet of the thermal fogging device which is advantageously selected from 110° C. to 200° C., it being understood that a particularly satisfactory mist is obtained at an outlet temperature of the thermal fogging device comprised between 130 and 180° C., preferably of about 160° C.

The application by thermal fogging may be continuous or intermittent during the period of storage. Preferably, the application is carried out in the storage enclosure prior to filling, or repeated, approximately every two months.

Nevertheless, under these normal working temperature conditions for thermal foggers (typically between 110 and 200° C., or even 240° C.), it has been identified that the mono- and diglycerides of fatty acids cannot be nebulised in a satisfactory fashion.

It had never before been envisaged to carry out the treatment processes on fruits and vegetables with fogging temperatures greater that 250° C.

Preferably, the thermal fogging temperature is comprised between 260 and 300° C.

The term “thermal fogging temperature” is understood in this instance to refer to the temperature of the mist at the outlet of the thermal fogging device.

It is understood that this thermal fogging temperature is distinct from the heating temperature at which the air is heated by the thermal fogger prior to the injection of the liquid.

According to one embodiment, the said mono- and diglycerides of dietary fatty acids are mono- and di-oleate of glycerol. Preferably, it is the additive E471.

It is obtained by hydrolysis, either from fats and animal products (beef stomachs, horns, lard, tallow, etc) or from plant oils (palm oil, soybean oil, olive oil, cottonseed oil, rapeseed oil, sunflower oil, etc). E471 is commercially available: it is notably distributed by Stéarinerie Dubois.

According to one embodiment, the said solvent is selected from a food grade solvent having a boiling point temperature of between 150 and 260° C.

Mention may in particular be made of monopropylene glycol.

It is specified in this instance that the said coating composition may comprise a plurality of solvents, it being understood that at least one of the said solvents has a boiling point of between 150 and 260° C.

Thus, according to one advantageous embodiment, the coating composition may in addition comprise ethanol, for example in an amount of 0 to 30% (by weight of the composition).

It has in fact been identified by the inventors that the presence of ethanol makes it possible to reduce the viscosity at low temperature in order to facilitate the aspiration of the pump for supplying the nebuliser.

According to one embodiment, the coating composition comprises:
between 5 and 60% by weight, preferably between 20 and 40% by weight of mono-and diglycerides of dietary fatty acids; and
between 40 and 95% by weight, preferably between 50 and 70% by weight of solvent.

Typically, the coating composition comprises:
between 20 and 40% by weight of mono- and diglycerides of dietary fatty acids; and
between 50 and 70% by weight of solvent.

Typically, the coating composition as previously defined above is applied without prior dilution, or can be dispersed in water, in particular hot water. In this case, the percentages indicated above are understood to be before dilution.

According to one embodiment, the said coating composition may comprise one or more additional ingredient(s) such as the additives usually used, in particular for the treatment of fruits or vegetables.

The coating composition may thus comprise in addition, one or more non-ionic emulsifier(s), lecithin, soybean oil, one or more base(s), water, one or more organic solvent(s) such as alcohols, and/or one or more emulsifier(s) such as Tween, such as Tween 80, sucroesters, ethoxylated fatty alcohols.

By way of fruits and vegetables, mention may in particular be made of pears, strawberries, apples, peaches, nectarines and apricots. The treatment is particularly advantageous for strawberries and pears.

The amount of product applied depends on the quantity of fruits and vegetables to be treated, as well as on the conditions of storage and the degree of ripeness of the fruits and vegetables stored and/or desired. In general, between 10 and 200 g of composition is to be applied per tonne of fruits and vegetables treated.

According to one embodiment, the contact time during which the fruits or vegetables are to be contacted with the said composition is between 10 seconds and 10 minutes.

The treatment may be carried out in the orchard or post-harvest, preferably post-harvest.

It may be carried out prior to the produce being placed in the storage room, or indeed within the storage room, such as a cold room.

The application of the said composition may be carried out on fruits and vegetables stored in boxes or on pallets, or preferably stored out of boxes or pallets, prior to the marketing thereof.

The following examples are provided by way of illustration of the present invention and without any limitation thereof.

### EXAMPLES

### 1. Preparation of a Coating Composition

For the preparation of 1 kg of coating product, it is necessary to add to 400 g of the food additive E471, 400 g of food solvent having a boiling point of between 150 and 260° C., such as monopropylene glycol having a boiling point of 184° C., and 200 g of ethyl alcohol.

### 2. Application and Effectiveness of the Coating Composition

Tests were carried out on pears (Abate Fetel), according to the following procedure:

In a refrigerated room at 2° C., the fruits were treated with the composition of Example 1 (1.5 L of composition thermonebulised at 295° C. with the Electrofog® device), while at the same time, a sample of fruits (untreated control) was maintained outside the refrigerated room and subsequently put back for storage in the room. In order to simulate the friction and shocks, each fruit was manually rolled on the ground for a period of about one minute. 8 days later (T1), 4 samples were subjected to manipulation: the control, one cold-treated sample, one sample subjected to manipulation after warming for a period of 18 hours, and one sample subjected to manipulation after warming for a period of 24 hours. All of the samples were visually assessed at 8 and 9 days, and thereafter returned to the enclosure. One week later (T2), two samples were subjected to manipulation and assessed: the control, and one treated sample.

### Result

After one week (T1), the fruits of the control sample turned black immediately after subjecting to the friction and shocks.

Among the treated fruits, those subjected to manipulation while cold, show black spots, while the fruits of the two samples that were subjected to warming (for a period of 18 hours or 24 hours) showed practically no damage.

Two weeks later (T2): The two samples which were subjected to manipulation at T1 and returned to the room show deterioration in quality. Several fruits in the control group show large black spots due to the manipulation. In addition, the treated samples show several black spots, but the fruits that have been subjected to manipulation after a period of warming have a better visual appearance and fewer black spots than the fruits that have been subjected to manipulation while cold.

Among the samples that were subjected to manipulation and assessed at T2, the control samples show some black spots related to friction and handling, while the treated sample has a better appearance with a lower level of degradation.

### Conclusions and Comments

The assessment of the fruits demonstrates that the treated samples are less damaged than the untreated fruit samples.

The effectiveness of the composition appears to be enhanced if the application is repeated, during storage.

### Comparative Example

The additive E471 has a high viscosity (at ambient temperature it is a paste): therefore it cannot be nebulised taken alone and must be diluted in a solvent in order to be fluidised.

The additive E471 was thus then diluted in ethyl alcohol in the same proportions as in Example 1. The mixture was then nebulised under the conditions described in Example 2, at a temperature equal to 240° C.

This nebulisation proved to be unsuccessful: the additive remained pure after evaporation of the ethanol.

1. A treatment process for treating fruits and vegetables by means of a coating composition, the said process including:
the thermal fogging of the said composition at a temperature comprised between 250° C. and 330° C.;
the application of the aerosol of the said composition thus obtained; and such that the said composition comprises:
one or more mono- and diglycerides of dietary fatty acids,
a solvent having a boiling point temperature of between 150 and 260° C.

2. The process according to claim 1, such that the said mono- and diglycerides of dietary fatty acids are the mono- and di-oleate of glycerol.

3. The process according to claim 1 such that the said solvent is monopropylene glycol.

4. The process according to claim 1, such that the composition comprises:
between 5 and 60% by weight of mono- and diglycerides of dietary fatty acids; and
between 40 and 95% by weight of solvent.

5. The process according to claim 1, such that the composition further comprises one or more emulsifier(s).

6. The process according to claim 1, such that the coating composition in addition comprises ethanol.

7. The process according to claim 1, that includes the fogging step of fogging the said composition at a temperature comprised between 260 and 300° C.

8. The process according to claim 1, that includes the application of 10 to 200 g of composition per ton of treated fruits and vegetables.

9. The process according to claim 1, that includes application of the composition within a storage room.

10. The process according to claim 1, such that the said fruits and vegetables are selected from strawberries and pears.
